(19) United States
(12) Patent Application Publication
(10) Pub. No.: US 2008/0256181 A1
(43) Pub. Date: Oct. 16, 2008

(54) SYSTEMS AND METHODS FOR ASYNCHRONOUS COLLABORATION AND ANNOTATION OF PATIENT INFORMATION

(75) Inventors: Mark Morita, Arlington Heights, IL (US); Steven Lawrence Fors, Chicago, IL (US); William Douglas Hughes, Bainbridge Island, WA (US)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, Schenectady, NY (US)

(21) Appl. No.: 11/735,300

(22) Filed: Apr. 13, 2007

(51) Int. Cl. G06F 15/16

(52) U.S. Cl. 709/204

(57) ABSTRACT

Certain embodiments of the present invention provide systems and methods for improved collaboration. Certain embodiments provide systems and methods for electronic medical record collaboration and annotation. Certain embodiments provide an electronic medical record collaboration system. The system includes a workstation having a user interface and access to electronic clinical data. The user interface allows annotation and saving of the electronic clinical data. The system also includes a collaboration manager coordinating collaboration between the workstation and another entity regarding the electronic clinical data. The collaboration is capable of being asynchronous or synchronous collaboration. Certain embodiments provide a method for collaboration with respect to electronic medical data. The method includes accessing electronic medical data; identifying a collaborator with respect to the electronic medical data; and collaborating in at least an annotation of the electronic medical data. The collaboration is capable of being an asynchronous or a synchronous collaboration.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention generally relates to patient information management. In particular, the present invention relates to systems and methods for synchronous and/or asynchronous collaboration and annotation of patient information.

In a healthcare or clinical environment, such as a hospital, a large number of employees and patients may result in confusion or delay when trying to reach other medical personnel for examination, treatment, consultation, or referral, for example. A delay in contacting other medical personnel may result in further injury or death to a patient. Additionally, a variety of distractions in a clinical environment may frequently interrupt medical personnel or interfere with their job performance. Furthermore, workspaces, such as a radiology workspace, may become cluttered with a variety of monitors, data input devices, data storage devices, and communication devices, for example. Cluttered workspaces may result in inefficient workflow and service to clients, which may impact a patient's health and safety or result in liability for a healthcare facility.

Healthcare environments, such as hospitals or clinics, include clinical information systems, such as hospital information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medical histories, imaging data, test results, diagnosis information, management information, and/or scheduling information, for example. The information may be centrally stored or divided among a plurality of locations. Healthcare practitioners may desire to access patient information or other information at various points in a healthcare workflow. For example, during surgery, medical personnel may access patient information, such as images of a patient's anatomy, that are stored in a medical information system. Alternatively, medical personnel may enter new information, such as history, diagnostic, or treatment information, into a medical information system during an ongoing medical procedure.

Additionally, in a healthcare workflow, healthcare providers often consult or otherwise interact with each other. Such interaction typically involves paging or telephoning another practitioner. Thus, interaction between healthcare practitioners may be time- and energy-consuming. Therefore, there is a need for a system and method to simplify and improve communication and interaction between healthcare practitioners.

Furthermore, healthcare practitioners may want or need to review diagnoses and/or reports from another healthcare practitioner. For example, a referring physician may want to review a radiologist's diagnosis and report with the radiologist and/or a technician. As another example, an emergency room physician may need to review results of an emergency room study with the radiologist and/or a family physician. Thus, there is a need for a system and method for notifying or informing appropriate parties of results in order to collaborate for diagnosis and/or treatment review for safe and effective treatment.

Current healthcare information technology software applications do not afford mechanisms to annotate, comment or collaborate on specific patient information. Current systems allow for communication via email, whereby screen captures with annotations are attached to the email. Unfortunately, email systems are not integrated with EMR applications so that the comment threads can be stored for historical reference. Thus, systems and methods for improved annotation, comment and collaboration would be highly desirable. Systems and methods allowing discussion threads and annotations to be stored with an EMR would also be highly desirable.

Typically, if healthcare practitioners desire to collaborate, healthcare practitioners determine each other's availability and schedule a collaboration event. Thus, current systems and methods require more manual involvement and multiple steps. Current systems encouraging interactions between healthcare practitioners consist of several discrete or manual actions involving a number of disparate systems and/or individuals. First, third parties are notified of information availability. Then, third parties obtain the information by accessing one or more systems. After a system verifies that the information has been received, the practitioner and third party must determine their availability for collaboration. After the parties schedule a mutually available time for collaboration, the parties may finally collaborate to review exam results, diagnosis, treatment, etc. The involvement of a plurality of disparate systems/parties and requirement of several disparate steps renders current systems and methods complicated, inefficient, and time consuming. An ability to reduce the number of actions required by interested parties, reduce the number of ineffective actions, and reduce the waiting time required to obtain necessary information and perform a collaboration would result in more efficient and effective healthcare delivery.

Thus, there is a need for systems and methods for improved patient information management. There is a need for systems and methods for synchronous and/or asynchronous collaboration and annotation of patient information. There is a need for systems and methods enabling collaboration and annotation with respect to an EMR.

### BRIEF SUMMARY OF THE INVENTION

Certain embodiments of the present invention provide systems and methods for improved collaboration. Certain embodiments provide systems and methods for electronic medical record collaboration and annotation.

Certain embodiments provide an electronic medical record collaboration system. The system includes a workstation having a user interface and access to electronic clinical data. The user interface allows annotation and saving of the electronic clinical data. The system also includes a collaboration manager coordinating collaboration between the workstation and another entity regarding the electronic clinical data. The collaboration is capable of being asynchronous or synchronous collaboration.

Certain embodiments provide a method for collaboration with respect to electronic medical data. The method includes accessing electronic medical data; identifying a collaborator with respect to the electronic medical data; and collaborating in at least an annotation of the electronic medical data. The collaboration is capable of being an asynchronous or a synchronous collaboration.

Certain embodiments provide a computer-readable storage medium including a set of instructions for a computer. The set of instructions includes a user interface routine providing access to electronic clinical data and tools for annotation and saving of the electronic clinical data and for collaboration with a collaborator. The set of instructions also includes a collaboration routine facilitating asynchronous and synchronous communication between two or more collaborators. The collaboration routine initiates actions and communication based on input from the user interface routine and contact information.

### BRIEF DESCRIPTION OF SEVERAL VIEWS OF THE DRAWINGS

FIG. 1 illustrates a collaboration system used in accordance with an embodiment of the present invention.

FIG. 2 illustrates an exemplary interface for access to a collaboration system in accordance with an embodiment of the present invention.

FIG. 3 illustrates an exemplary user interface providing collaboration options with another user in accordance with an embodiment of the present invention.

FIG. 4 shows an exemplary interface providing annotation of patient information in accordance with an embodiment of the present invention.

FIG. 5 depicts a flow diagram for a method for collaboration and electronic medical record annotation in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Certain embodiments provide systems and methods for annotation and/or comment on any screen within a healthcare information system, for example. Annotations can be saved as part of an electronic medical record (EMR). In certain embodiments, an EMR includes asynchronous and/or synchronous collaboration functionality allowing users to send annotations/comments to colleagues for review and remote consultations. Certain embodiments use presence management to facilitate collaboration via the EMR, for example.

In certain embodiments, users select to enter an annotation mode where they are able to use drawing tools and/or other functionality to highlight specific clinical information. For example, users are able to type and/or print (e.g., using handwriting recognition) on an information screen displaying a patient report and/or other information. Users are able to add voice annotations (e.g., as audio files in .wav, .mp3, etc., formats) that attach to highlighted annotations and/or other electronic medical record data, for example.

Via presence management, users are able to see which of their colleagues are available for asynchronous/synchronous collaboration sessions. In certain embodiments, a system also tracks which healthcare professionals are associated with specific patient information. Users are able to send collaboration requests to their colleagues.

A system attaches annotations and/or other comments, collaboration data, etc. to the patient's medical record. For example, collaboration message threads may be saved to the patient's medical record to indicate that the information has been read, provide action items, provide follow-up diagnoses, etc. Information, such as collaboration message threads, annotations, etc., may help allow clinical communications between healthcare providers to be stored, tracked and facilitated through asynchronous, as well as synchronous, collaboration systems. Message threads can be stored within a patient's electronic medical record rather than and/or in addition to being stored in a remote email account/client, for example.

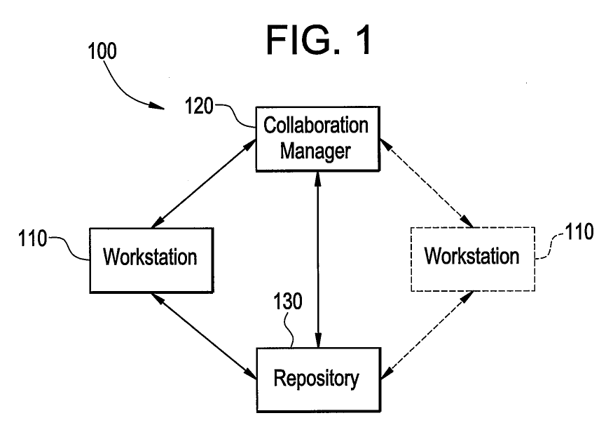

FIG. 1 illustrates a collaboration system 100 used in accordance with an embodiment of the present invention. The collaboration system 100 includes one or more workstations 110, a collaboration manager 120 which may or may not be integrated with one or more of the workstations 110 and a medical record repository 130, for example. The system 100 may also include one or more networks, such as an Internet protocol (IP) network, a cellular network and/or a public switched telephone network (PSTN), for communication with other systems and/or users, for example. The system 100 may also include a modality, for example.

In an embodiment, the system 100 is or includes a Picture Archiving and Communication System (PACS), healthcare or hospital information system (HIS), a radiology information system (RIS), a clinical information system (CIS), a cardiovascular information system (CVIS), a library information system (LIS), order processing system, and/or an electronic medical record (EMR) system, for example.

The workstation 110, such as a PACS workstation, and/or other interface or data processing device (e.g., laptop, tablet computer, personal digital assistant, handheld computer, cellular phone, etc.), may be used to access (e.g., input and retrieve data) the repository 130 and/or other workstation 110. The workstation 110 may communicate via wired, wireless, and/or infrared communication, for example. Vocal/subvocal command and/or other forms of communication and control may be used to interface with the workstation 110, collaboration manager 120, repository 130, etc. In an embodiment, a password and/or other authentication, such as voice or other biometric authentication, may be used to establish a connection between the workstation 110 and the collaboration manager 120 and/or repository 130.

The workstation 110 and/or repository 130 may interact with one or more modalities, such as an x-ray system, computed tomography (CT) system, magnetic resonance (MR) system, ultrasound system, digital radiography (DR) system, positron emission tomography (PET) system, single photon emission computed tomography (SPECT) system, nuclear imaging system, and/or other modality. The image workstation 110 and/or repository 130 may acquire image data and related data from a modality for processing and/or storage.

The workstation 110 is connected with the collaboration manager 120 via wired, wireless and/or infrared communication, for example. The collaboration manager 120 may be a separate system or may be integrated with the workstation 110, for example. The collaboration manager 120 may be a server, workstation, medical information system, and/or other computing system, for example. The collaboration manager 120 receives information from the workstation 110 and/or repository 130 and transmits information via a communication medium/device, such as a wired or wireless modem, cellular transmission, infrared transmission, Ethernet, fire wire, Internet, virtual private network, public switched telephone network, dial-up, local area network, and/or wide area network, for example.

The collaboration manager 120 may facilitate a plurality of functions, such as handling event notifications and requests from the workstation 110, managing contact information for a set of subscribers or members, providing notification to subscribers of events, managing calls for collaboration events, managing multi-media streams for collaboration events, and/or managing presence information and status for subscribers or members. The collaboration manager 120 handles communications tasks associated with notification, collaboration, and/or data transfer in a medical enterprise, for example.

The collaboration manager 120 may transmit information and/or notification to a network, such as a telephone network and/or the IP network, for example. The collaboration manager 120 may automatically schedule consultation calls, for example. In an embodiment, the telephone network facilitates communication with “landline” telephones and/or cellular phones, for example. The IP network may facilitate communication with personal digital assistants (PDAs), laptops, IP telephones, and/or workstations, for example, transferring data according to Internet Protocol.

The workstation 110 may receive examination data, such as image data, and additional information from the collaboration manager 120, repository 130, modality and/or other data source. Additional information may indicate findings within the image data, diagnosis information, treatment information, and/or consultation or referral information, for example. A request to notify/consult may be identified based on certain rules, filters, and/or lexical analysis, for example. For example, the workstation 110 sends a message to the collaboration manager 120 to set up a collaboration session with another practitioner at a given time or at a time when all parties are available, for example.

The collaboration manager 120 may schedule a conference, such as a multimedia conference, based on provided contact information, such as contact information for the radiologist and for the referring physician. In an embodiment, the collaboration manager 120 includes call processing rules, input parameters, preferences, and/or other input information, for example. The manager 120 may schedule a call based on such information. For example, information/preferences may include specific times and/or time periods, location, type of communication (e.g., cell phone, computer, etc.), availability, etc.

The collaboration manager 120 may store profile(s) and/or contact information for members/subscribers, for example. The collaboration manager 120 may select one or more contact devices from a user's profile to initiate a communication (e.g., cellular phone, office phone, home phone, pager, laptop IP address, etc.). For example, the collaboration manager 120 may initiate a connection between a physician's cellular phone and a radiologist's workstation. Additionally, the collaboration manager 120 may save or have access to a calendar or schedule for each user. The collaboration manager 120 may determine when a user is available and on what device, for example.

In an embodiment, the collaboration manager 120 may also look for a “presence” of a user in the system 100. That is, the collaboration manager 120 determines whether the user is registered or “logged in” in the healthcare environment. For example, the manager 120 may determine whether the referring physician has his or her cellular phone switched on. In an embodiment, a user may set presence parameters, such as available, away, busy, do not disturb except for certain occurrence(s), etc. For example, a surgeon may set his or her status to do not disturb except for emergencies when in surgery.

In operation, for example, a user at a workstation 110 may initiate a collaboration session with another user via the collaboration manager 120. In certain embodiments, the collaboration manager 120 contacts the second user based upon a prescribed set of rules that determine how the user may be contacted. Contact may be achieved through data communication, such as over an IP network, and/or through telephone communication, such as a PSTN network. The type of contact client, such as a workstation, PDA, cell phone, etc., determines the type of information provided to the second user in the notification message, such as a reference to the exam, contact phone number or email address, meeting time, etc. Certain embodiments allow the workstation 110 and/or collaboration manager 120 to initiate a synchronous calibration request or asynchronous annotation, comment and/or other message regarding a patient medical record or other data.

In certain embodiments, the system 100 may be used to facilitate collaboration to share display content and/or activity between workstation(s) 110, repository 120, modality, etc. For example, studies, reports, images, annotations, regions of interest, audio, video, text, and/or other information may be shared. Conferencing features of the system 100 help improve resident workflow, expert consultation, and/or teaching hospitals, for example.

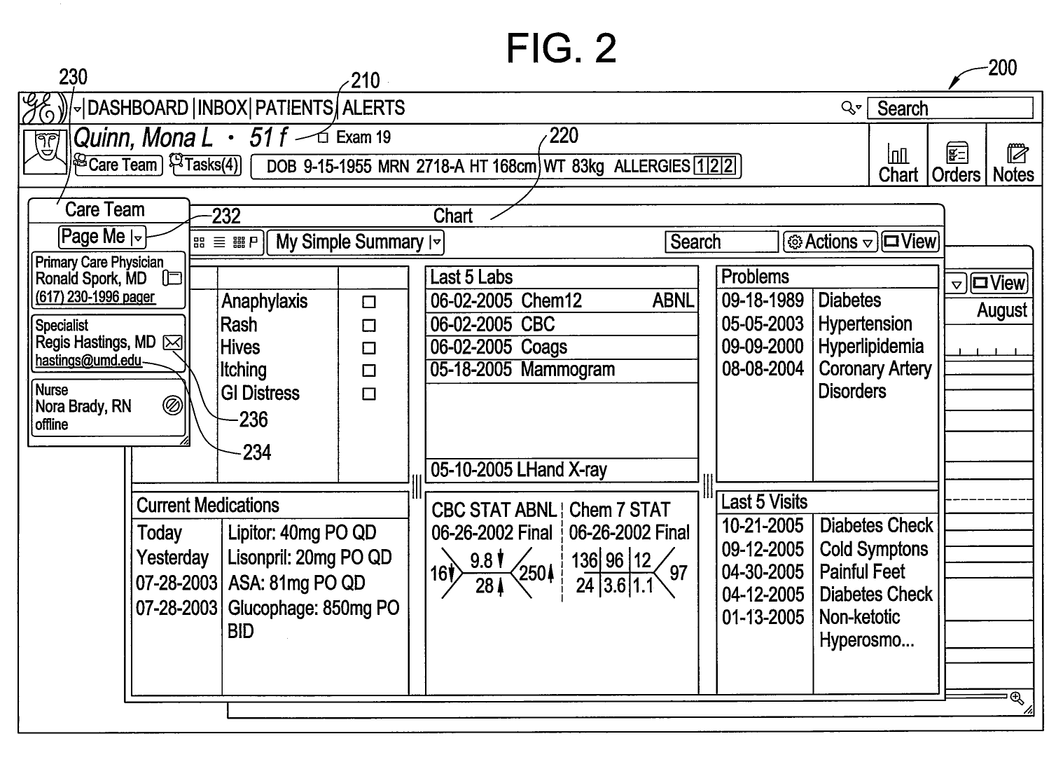

FIG. 2 illustrates an exemplary interface 200 for access to a collaboration system in accordance with an embodiment of the present invention. The exemplary interface 200 provides patient information 210, such as a patient chart 220. The interface 200 provides a contact list 230, such as a care team contact list, which includes a page button 232 one or more contacts 234, and a preferred method of contact 236. For example, a care team contact list shown in FIG. 2 includes a plurality of contacts 234 for collaboration, including a nurse, a specialist and a primary care provider. The icon 236 associated with each contact 234 identifies a device, such as electronic mail, telephone, cellular phone, etc., by which the contact 234 is most accessible. Thus, the contact 234 and method of contact 236 information provide information to determine which colleagues are available for consultation and by which device the colleagues are most accessible.

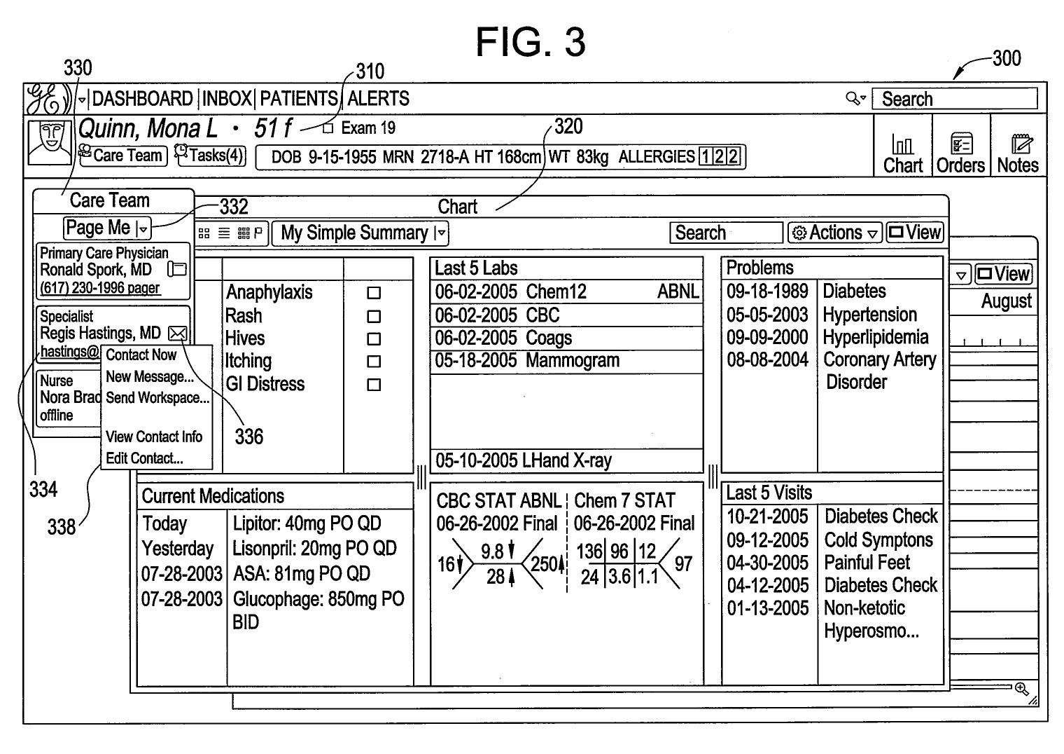

FIG. 3 illustrates an exemplary user interface 300 providing collaboration options with another user in accordance with an embodiment of the present invention. For example, once a user selects someone from his or her collaboration list, a drop down menu and/or other listing allows the user to see what actions he or she can perform with the particular collaborator. As shown in FIG. 3, the interface 300 provides patient information 310, including a patient chart 320. The interface 300 provides a contact list 330 including a pager option 332, one or more contacts 334 and method(s) of contact 336. When a contact 334 is selected, an additional menu 338, such as a drop down menu, provides contact options for the contact 334. For example, a drop down menu 338 may provide options to contact a user now, edit a new message for the contact, send workspace information/invitation to the contact, vie contact information and/or edit contact information, for example.

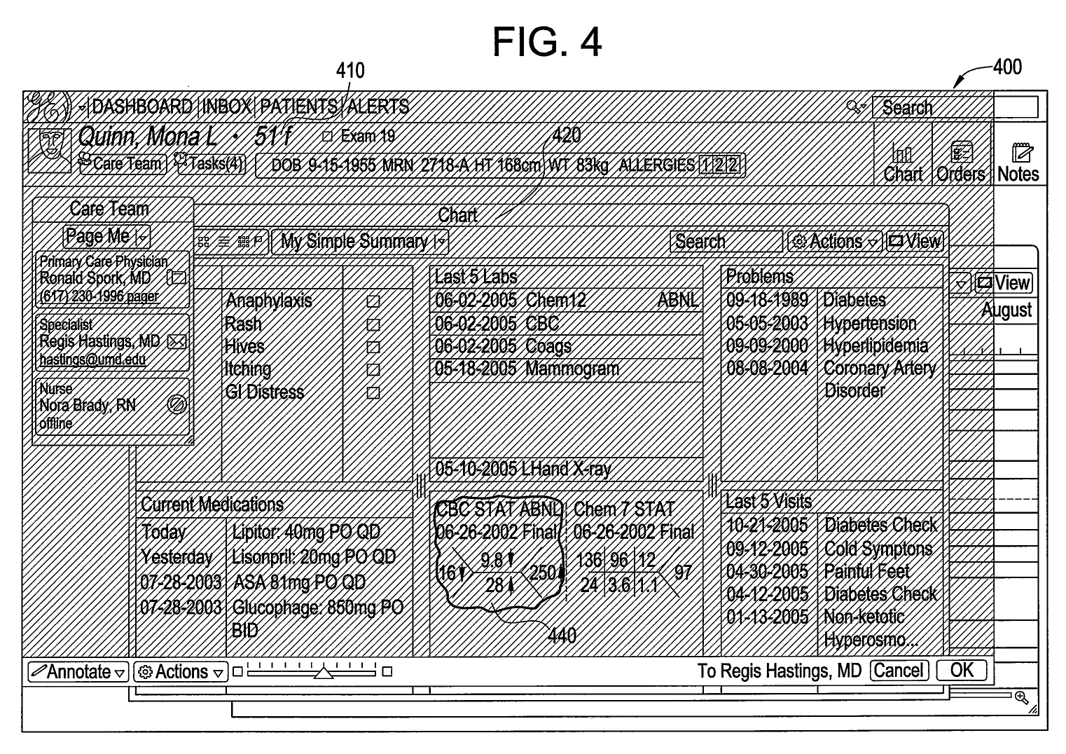

As shown in FIG. 4, once a user initiates an annotation mode, he or she is able to annotate a record such as via handwriting recognition and/or by using the annotation tools provided. Users may also add textual notes entered via keyboard, handwriting recognition or voice dictation system, for example. As shown in FIG. 4, an interface 400 includes patient information 410, such as a patient chart 420. An annotation 440 allows a user to encircle and highlight information in the patient chart 420. In certain embodiments, annotations may be shared with other user(s) and/or saved with patient record data, for example.

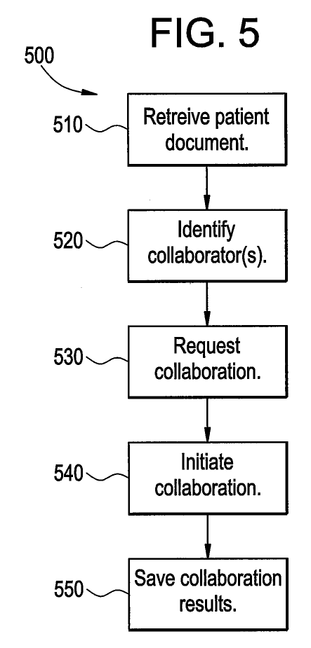

FIG. 5 depicts a flow diagram for a method 500 for collaboration and electronic medical record annotation in accordance with an embodiment of the present invention. At step 510, a patient document is retrieved. For example, an electronic patient chart is retrieved from the data repository 130 for viewing at the workstation 110 via a user interface or other viewer.

At step 520, a collaborator is identified. For example, a specialist is selected from a list of available collaborators displayed via a user interface at the workstation 110. At step 530, collaboration is requested. For example, a selected collaborator may be contacted in real-time for a collaboration and/or the selected collaborator may be notified to schedule a future collaboration. For example, the collaboration manager 120 may check the schedules of the requesting party and the collaborating party to determine a commonly available time slot. In certain embodiments, a plurality of collaborators may be contacted. In certain embodiments, collaboration may proceed asynchronously without all collaborating parties being present at once.

At step 540, collaboration is initiated between participating parties. Collaboration may be initiated through the collaboration manager 120 and one or more workstations 110, for example. Collaborators may synchronously and/or asynchronously annotate patient information, such as a patient chart, add comments to patient information and/or hold a discussion regarding the patient information, for example. At step 550, results of a conference or collaboration may be saved at the workstation 110 and/or repository 130, for example.

Thus, certain embodiments provide increased efficiency in a medical workflow through improved collaboration and annotation of electronic patient data. Certain embodiments help improve collaboration and referral between healthcare practitioners. Certain embodiments help enhance patient safety and quality of treatment through a more robust notification and collaboration mechanism that helps to insure that results and appropriate information or collaboration needs are scheduled and executed. Certain embodiments provide an ability and technical effect of being able to review, edit, annotate and collaborate regarding electronic medical record data, which can be saved for later retrieval and/or other use.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. An electronic medical record collaboration system, said system comprising:
a workstation having a user interface and access to electronic clinical data, said user interface allowing annotation and saving of said electronic clinical data; and
a collaboration manager coordinating collaboration between said workstation and another entity regarding said electronic clinical data, wherein said collaboration is capable of being asynchronous or synchronous collaboration.

2. The system of claim 1, wherein said electronic clinical data comprises a patient electronic medical record.

3. The system of claim 1, further comprising a plurality of workstations capable of collaboration via said collaboration manager.

4. The system of claim 1, wherein said collaboration manager provides a contact list including one or more contact devices associated with a user.

5. The system of claim 4, wherein said collaboration manager detects a presence of a user based on said contact list.

6. The system of claim 1, further comprising a modality transmitting image data to said workstation.

7. The system of claim 1, wherein said user interface provides drawing tools to highlight and annotate a portion of said electronic clinical data.

8. The system of claim 1, wherein said user interface and said workstation attach user annotation and collaboration information to said electronic clinical data.

9. The system of claim 1, wherein said collaboration manager tracks one or more users associated with said electronic clinical data.

10. The system of claim 1, wherein said annotation comprises at least one of handwriting recognition and voice annotation.

11. A method for collaboration with respect to electronic medical data, said method comprising:
accessing electronic medical data;
identifying a collaborator with respect to said electronic medical data; and
collaborating in at least an annotation of said electronic medical data, wherein said collaboration is capable of being an asynchronous or a synchronous collaboration.

12. The method of claim 11, further comprising saving said electronic medical data with said annotation.

13. The method of claim 11, wherein said electronic clinical data comprises a patient electronic medical record.

14. The method of claim 11, wherein said identifying step further comprises identifying a collaborator based on a contact list including one or more contact devices associated with a potential collaborator.

15. The method of claim 1, wherein said annotation comprises at least one of highlighting a portion of said electronic medical data, handwriting recognition for comment regarding said electronic medical data, exchange of messages regarding said electronic medical data and voice annotation of said electronic medical data.

16. The method of claim 1, further comprising tracking one or more collaborators associated with said electronic medical data.

17. A computer-readable storage medium including a set of instructions for a computer, the set of instructions comprising:
a user interface routine providing access to electronic clinical data and tools for annotation and saving of said electronic clinical data and for collaboration with a collaborator; and
a collaboration routine facilitating asynchronous and synchronous communication between two or more collaborators, wherein said collaboration routine initiates actions and communication based on input from said user interface routine and contact information.

18. The computer readable medium of claim 17, wherein said collaboration management routine accesses a profile for each of said two or more collaborators to initiate communication.

19. The computer readable medium of claim 17, wherein said collaboration routine monitors a network for a presence of a collaborator.

20. The computer readable medium of claim 17, wherein said annotation comprises at least one of highlighting a portion of said electronic clinical data, handwriting recognition for comment regarding said electronic clinical data, exchange of messages regarding said electronic clinical data and voice annotation of said electronic clinical data.
